(19) United States
(12) Patent Application Publication
(10) Pub. No.: US 2024/0379994 A1
(43) Pub. Date: Nov. 14, 2024

(54) Lithium-Ion Battery and Method for Preparing the Same

(71) Applicant: Vidyasirimedhi Institite of Science and Technology (VISTEC), Rayong (TH)

(72) Inventors: Montree Sawangphruk, Bangkok (TH); Sangchai Sarawatanukul, Bangkok (TH); Farkfun Duriyasart, Nonthaburi (TH); Poramane Chlochan, Bangkok (TH); Nutthaphon Phattharasupakun, Nonthaburi (TH); Juthaporn Wuttiprom, Sisaket (TH); Chanikarn Tomon, Bangkok (TH); Atiweena Krittayavathananon, Bangkok (TH); Salatan Duangdangchote, Nonthaburi (TH); Worapol Tejangkura, Bangkok (TH); Chonticha Jangsan, Maha Sarakham (TH)

(21) Appl. No.: 18/696,832

(22) PCT Filed: Dec. 3, 2021
(86) PCT No.: PCT/IB2021/061271

§ 371 Date: Mar. 28, 2024

(30) Foreign Application Priority Data
Sep. 28, 2021 (TH) 2101006018

(51) Int. Cl. H01M 10/0525; H01M 4/02; H01M 4/04; H01M 4/525; H01M 4/583; H01M 4/62; H01M 4/66; H01M 10/0567; H01M 10/0568; H01M 10/0569

(52) U.S. Cl. CPC H01M 10/0525; H01M 4/0404; H01M 4/0471; H01M 4/525; H01M 4/583; H01M 4/623; H01M 4/625; H01M 4/661; H01M 10/0567; H01M 10/0568; H01M 10/0569; H01M 2004/027; H01M 2004/028; H01M 2300/0037; H01M 2300/0051

(57) ABSTRACT

The present invention relates to a lithium-ion battery comprising a cathode comprising an active material comprising lithium nickel cobalt aluminum oxide compound, an anode comprising active material comprising graphite, and an electrolyte comprising lithium salt, carbonate solvent, and an additive, wherein lithium nickel cobalt aluminum oxide compound has a formula Li(NiₐCo_{b}Al_{c})O₂, whereby a≥0.85, 0<b<1, 0<c<1 and the sum of a, b, and c is 1, and the additive is fluoroethylene carbonate in an amount ranging from 0.2-4 vol %, based on the total amount of electrolyte. Furthermore, the invention also discloses a method for preparing the lithium-ion battery according to the present invention.

### TECHNICAL FIELD

Chemical technology related to a lithium-ion battery and a method for preparing the same

### BACKGROUND OF THE INVENTION

An 18650 cylindrical battery is considered a widely used energy storage source in commercial applications. The 18650 code indicates the battery diameter of 18 mm and the battery length of 65 mm, while 0 refers to a cylindrical battery. This type of battery can be used in both portable electrical devices, such as a backup battery for mobile phones which requires a capacity of approximately 2.5-10 mAh, and large electrical machinery, such as a plug-in hybrid vehicle or an electric vehicle. The cylindrical battery used in these large electrical machinery requires an energy storage of approximately 100 kWh for driving. For this reason, there is a need for batteries with high capacity and safety in application to respond to the rising demand for energy.

The cylindrical battery generally consists of a cathode and an anode with a separator between them to prevent a short circuit of the battery. The anode is usually a graphite material having a theoretical capacity of approximately 372 mAh/g and a high stability due to only 10% volume expansion upon an electrochemical reaction. With regard to the cathode material, a cathode material which garners a lot of attention is lithium nickel cobalt aluminum oxide (NCA) material, which has a high capacity of 160-180 mAh/g, high stability compared to other types of the cathode material having cobalt as a component, low price, good performance at high voltage, and operating voltage range of approximately 3.7 V. As a result, lithium nickel cobalt aluminum oxide is widely used in commercial applications.

One of the important keys to increase the energy density per NCA battery price is to reduce the amount of cobalt, which is a costly element, and increase the nickel ratio. The capacity of this material varies directly with the amount of nickel in the structure. For example, the NCA battery in the market has the mole ratio of Ni:Co:Al of 0.80:0.15:0.05, respectively, which provides a capacity of 160 mAh/g and the battery used in Tesla electric vehicle Model 3 uses nickel cobalt aluminum oxide material at the mole ratio of Ni:Co:Al of 0.84:0.12:0.04, respectively, which provides a capacity of 180 mAh/g. However, the higher amount of nickel in a crystal structure results in a lower thermal stability of this material which could lead to a higher exothermic reaction in application and an explosion. The method which could alleviate this problem depends on a suitable condition for the preparation of the electrodes, as well as the battery assembly and the addition of an additive to reduce the electrochemical reaction of said material. Examples of related patent document are as follows.

U.S. Pat. No. 8,334,404 B2 discloses the use of lithium tetrafluorophosphate as an additive in the lithium hexafluorophosphate electrolyte solution in a carbonate solvent.

U.S. Pat. No. 7,879,499 B2 discloses an electrolyte for lithium-ion secondary battery which includes a non-aqueous organic solvent, lithium salt, difluoro oxalato borate, and fluoroethylene carbonate.

EP 1 970 989 B1 discloses an electrolyte for a rechargeable lithium battery comprising a non-aqueous organic solvent, halogenated ethylene carbonate in an amount ranging from 0.1-10% by weight, based on the total amount of electrolyte, and vinylethylene carbonate in an amount ranging from 0.1-3% by weight, based on the total amount of electrolyte.

Nevertheless, the aforementioned patent documents do not emphasize on improving the efficiency of the NCA battery, especially the efficiency of the NCA battery with a high nickel ratio.

### SUMMARY OF THE INVENTION

In one aspect, the present invention relates to a lithium-ion battery comprising a cathode comprising an active material comprising lithium nickel cobalt aluminum oxide (NCA) compound, an anode comprising an active material comprising graphite, and an electrolyte comprising lithium salt, carbonate solvent, and an additive, wherein lithium nickel cobalt aluminum oxide compound has a formula Li(NiₐCo_{b}Al_{c})O₂, whereby a≥0.85, 0<b<1, 0<c<1 and the sum of a, b, and c is 1 and the additive is fluoroethylene carbonate in an amount ranging from 0.2-4 vol % based on the total amount of electrolyte.

In another aspect, the present invention relates to a method for preparing the lithium-ion battery according to the present invention. The method comprises the steps of:
(a) preparing the cathode by coating a substrate with a mixture of active material, conductive material, and binder in a solvent and drying the coated substrate,
(b) preparing the anode by coating a substrate with a mixture of active material, conductive material, and binder in a solvent and drying the coated substrate,
(c) assembling the cathode obtained from step (a) and the anode obtained from step (b) in a battery case, and
(d) filling the electrolyte into the battery assembled in step (c),
wherein the filling of electrolyte according to step (d) is carried out with a weight ratio of electrolyte to battery ranging from 1-1.3 to 8-9.

The present invention is aimed at improving the charge-discharge efficiency and safety of the lithium-ion battery having the NCA cathode, especially the lithium-ion battery having the NCA cathode with a particularly high nickel ratio, e.g., 85% or higher.

The invention is also aimed at developing a method for preparing the lithium-ion battery having the NCA cathode with a particularly high nickel ratio to obtain an optimal condition for the preparation of the battery with high charge-discharge efficiency and application safety.

### BRIEF DESCRIPTION OF THE DRAWINGS

FIG. 1 is images obtained from a scanning electron microscope (SEM) showing the characteristic of a surface of the cathode active material of the battery according to the present invention at a 10,000× magnification (FIG. (1a)) and 50,000× magnification (FIG. (1b)).

FIG. 2 is images obtained from the scanning electron microscope together with an analysis of elements and composition using an energy dispersive X-ray spectrometer (EDS) showing the analysis of elements of the cathode active material of the battery according to the present invention.

FIG. 3 is a graph obtained from an X-ray diffraction (XRD) analyzer showing a structure of the cathode active material of the battery according to the present invention.

FIG. 4 is graphs showing the charge-discharge profile of the battery according to the present invention after being subjected to a single-step current charging (FIG. (4a)) and multi-step constant current (MSCC) charging (FIG. (4b)), formation process at a C-rate of 0.05 and 0.01.

FIG. 5 is graphs showing the charge-discharge profile of the battery according to the present invention, of which the cathode is obtained by coating the substrate at thicknesses of 140 μm (FIG. (5a)), 160 μm (FIG. (5b)), 180 μm (FIG. (5c)), 200 μm (FIG. (5d)), 220 μm (FIG. (5e)), and 230 μm (FIG. (5f)).

FIG. 6 is a graph showing the charge-discharge profiles of the battery according to the present invention, of which the electrolyte comprises fluoroethylene carbonate (FEC) in different amounts, and a comparative battery which does not contain fluoroethylene carbonate.

FIG. 7 is a graph showing the capacity retention at different cycle numbers of the battery according to the present invention, of which the electrolyte comprises fluoroethylene carbonate in different amounts, and a comparative battery which does not contain fluoroethylene carbonate.

FIG. 8 is graphs showing the charge-discharge profile of the battery according to the present invention.

FIG. 9 is graphs showing the capacity retention at different cycle numbers of the battery according to the present invention in an application with a voltage range of 3-4.2 V (FIG. (9a)) and 3-4.05 V (FIG. (9b)).

FIG. 10 is images obtained from the scanning electron microscope at different magnifications showing the top view and the cross-sectional view of the cathode active material of the battery according to the present invention after 100 charge-discharge cycles.

### DETAILED DESCRIPTION

Any aspects shown herein shall encompass the application to other aspects of the present invention as well, unless specified otherwise.

Any tools, devices, methods, materials, or chemicals mentioned herein, unless specified otherwise, mean the tools, devices, methods, materials, or chemicals generally used or practiced by a person skilled in the art, unless explicitly specified as special or exclusive tools, devices, methods, materials, or chemicals for the present invention.

The terms “comprise(s),” “consist(s) of,” “contain(s),” and “include(s)” are open-end verbs. For example, any method which “comprises,” “consists of,” “contains” or “includes” one component or multiple components or one step or multiple steps is not limited to only one component or one step or multiple steps or multiple components as specified, but also encompass components or steps that are not specified.

The first aspect of the invention relates to the lithium-ion battery comprising:
the cathode comprising the active material comprising lithium nickel cobalt aluminum oxide compound,
the anode comprising the active material comprising graphite, and
the electrolyte comprising lithium salt, carbonate solvent, and the additive,
wherein lithium nickel cobalt aluminum oxide compound has the formula Li(NiₐCo_{b}Al_{c})O₂, whereby a≥0.85, 0<b<1, 0<c<1 and the sum of a, b, and c is 1, and the additive is fluoroethylene carbonate in the amount ranging from 0.2-4 vol %, based on the total amount of electrolyte.

Preferably, lithium salt can be selected from lithium hexafluorophosphate (LiPF₆), lithium oxalyldifluoroborate (LiODFB), lithium tetrafluoroborate (LiBF₄), lithium bis(oxalato)borate (LiBOB), lithium bis(trifluoromethanesulfonyl)imide (LiTFSI), lithium perchlorate (LiClO₄), and a mixture thereof.

Carbonate solvent is preferably a mixture of ethyl carbonate, dimethyl carbonate, and ethyl methyl carbonate, wherein a volume ratio of ethyl carbonate to dimethyl carbonate to ethyl methyl carbonate is 1:1:1.

According to the present invention, the cathode may further comprise a conductive material, which is carbon material, and a binder, which is polyvinylidene fluoride (PVDF), wherein a weight ratio of active material to conductive material to binder is in a range of 90-95.2 to 2.4-5 to 2.4-5.

The anode may further comprise a conductive material, which is carbon material, and a binder, which is carboxymethyl cellulose (CMC) and styrene-butadiene rubber (SBR), wherein a weight ratio of active material to conductive material to binder to carboxymethyl cellulose to styrene-butadiene rubber is 96.6:0.9:1.3:1.2.

The second aspect of the present invention relates to the method for preparing the lithium-ion battery according to the invention with the characteristics mentioned above, especially the preparation of a cylindrical battery. The method comprises the steps of:
(a) preparing the cathode by coating the substrate with the mixture of active material, conductive material, and binder in the solvent and drying the coated substrate,
(b) preparing the anode by coating the substrate with the mixture of active material, conductive material, and binder in the solvent and drying the coated substrate,
(c) assembling the cathode obtained from step (a) and the anode obtained from step (b) in the battery case, and
(d) filling the electrolyte into the battery assembled in step (c),
wherein the filling of electrolyte according to step (d) is carried out with the weight ratio of electrolyte to battery ranging from 1-1.3 to 8-9.

Preferably, the preparation of cathode according to step (a) is carried out as follows:
the mixture of active material, conductive material, and binder in the solvent according to step (a) can be obtained by a stirring under vacuum using N-methylpyrrolidone as a solvent,
the mixture of active material, conductive material, and binder in the solvent according to step (a) has a viscosity ranging from 6,500-7,000 cP,
the coating of the substrate with the mixture of active material, conductive material, and binder in the solvent according to step (a) is performed at a coating thickness ranging from 180-230 μm,
the drying of the coated substrate according to step (a) is carried out by heating at a temperature ranging from 120-140° C., and
the substrate according to step (a) is aluminium.

Preferably, the preparation of anode according to step (b) is carried out as follows:
the mixture of active material, conductive material, and binder in the solvent according to step (b) can be obtained by a stirring under vacuum using ethanol and deionized water as solvents,
the mixture of active material, conductive material, and binder in a solvent according to step (b) has a viscosity ranging from 5,200-5,500 cP,
the coating of the substrate with the mixture of active material, conductive material, and binder in the solvent according to step (b) is performed at a coating thickness ranging from 180-230 μm,
the drying of the coated substrate according to step (b) is carried out by heating at a temperature ranging from 100-120° C., and
the substrate according to step (b) is copper.

Preferably, the filling of electrolyte to the battery according to step (d) is performed in an atmosphere where humidity and oxygen is lower than 0.1 ppm.

The method for preparing the lithium-ion battery according to the present invention may further comprise step (e) of formation of the battery obtained from step (d), wherein the formation according to step (e) is carried out by a single-step current charging at a C-rate in a range of 0.01-0.05C or a 2-4-step constant current charging.

The present invention will now be described in more detail with reference to the example of the invention and the test result which will be discussed hereinafter with reference to the accompanying drawings but is not intended to limit the scope of the invention in any way.

### Example

An exemplary lithium-ion battery according to the present invention is prepared with the details as follows.

### (a) Preparation of the Cathode Active Material

The cathode active material was prepared by washing its surface using an automatic mixer by mixing 2,000-3,000 g lithium nickel cobalt aluminum oxide material with 1.5-2 liter ethanol at a concentration of 80-90 vol % and stirring with a large paddle at a speed of 40 rpm and a small paddle at 2,000 rpm for 2 hours under vacuum, then filtering and heating under vacuum at a temperature of 80° C. for 48 hours.

### (b) Preparation of the Cathode

A process of mixing the materials used to make the cathode was carried out using an automatic mixer by mixing 80-120 g polyvinylidene fluoride serving as a binder with 2,000-3,000 g N-methyl-2-pyrrolidone solution, stirring with a large paddle at a speed of 80 rpm and a small paddle at 3,000 rpm for one hour under vacuum. Then, 80-120 g carbon material serving as a conductive material was added and stirred for one more hour under vacuum. Then, 3,500-4,500 g lithium nickel cobalt aluminum oxide material obtained from step (a) was added to the solution and stirred for one more hour under vacuum. The ratio of lithium nickel cobalt aluminum oxide material to carbon material to polyvinylidene fluoride was in a range of 90-95.2 to 2.4-5 to 2.4-5 parts by weight, respectively. Then, about 200-600 g N-methyl-2-pyrrolidone solution was added to adjust the viscosity of the mixture. The viscosity of the mixture is preferably in a range of 6,500-7,000 cP. The mixture was then coated onto an aluminium sheet used as a substrate using an automatic coater. The coating thickness varied from 180-230 μm. The heating temperature was 120-140° C.

### (c) Preparation of the Anode

A process of mixing the materials used to make the anode was carried out using an automatic mixer by mixing 30-50 g carboxymethyl cellulose serving as a binder and 100-200 g ethanol in 2,000-3,000 g deionized water and stirring with a large paddle at a speed of 80 rpm and a small paddle at 3,000 rpm for one hour under vacuum. About 20-40 g carbon material serving as a conductive material was then added to the solution and stirred for another 30 minutes under vacuum. Then, 80-120 g ethanol was added to the solution and stirred for another 30 minutes under vacuum. Then, 2,500-3,500 g graphite serving as an active material was added and stirred for one more hour under vacuum. Then, 80-100 g styrene-butadiene rubber serving as another binder and 250-700 g deionized water were added and stirred for one more hour under vacuum. Then, 500-800 g additional deionized water was added and stirred under vacuum until the mixture was combined. The viscosity of the mixture is preferably in a range of 5,200-5,500 cP. The ratio of graphite material to carbon material to carboxymethyl cellulose to styrene-butadiene rubber was 96.6 to 0.9 to 1.3 to 1.2 parts by weight, respectively. Then, said substance was coated onto the copper sheet used as a substrate using an automatic coater with a coating thickness varied from 180-230 μm. The heating temperature was 100-120° C.

### (d) Assembly of the Battery

The cathode and the anode prepared according to steps (b) and (c) were assembled into an 18650 cylindrical battery. The assembly started with calendering the cathode and the anode using an automatic calendaring machine with a pressure of 6 tons to obtain the thickness of the cathode and the anode in a range of 100-200 μm. Then, the cathode and the anode were cut into 5.6 and 5.8 cm in width, respectively, and 60-80 cm in length using an automatic cutter. Then, the head portion of the cathode was welded with an aluminium strip using a welding machine and the end portion of the anode was welded with a nickel strip using a welding machine as well. The electrodes were then wound together with a ceramic film between the two electrodes to prevent a short circuit using an automatic winding machine. The wound electrodes were then loaded into an 18650 cylindrical battery case. The case containing the electrodes was then subjected to a case grooving process. Then, a battery cap was welded to the electrodes inside the battery case before filling with 5-6.5 g electrolyte per one battery, which has a total weight of about 40-45 g, in an atmosphere-controlled chamber with the humidity and oxygen level lower than 0.1 ppm. The electrolyte solution used was lithium hexafluorophosphate which was dissolved in a mixed solution of ethyl carbonate, dimethyl carbonate, and ethyl methyl carbonate in a volume ratio of 1 to 1 to 1. The fluoroethylene carbonate additive was added in an amount of 4 vol %. The battery was then sealed using an automatic battery sealing machine before wrapping the battery with a PVC sheet at a temperature of 140° C. in a belt oven.

### Test Result

The exemplary 18650 cylindrical battery according to the present invention prepared above was tested for its efficiency using an electrochemical technique. The test result is explained below in conjunction with the accompanying drawings.

### Study on the Characteristic of the Cathode Active Material

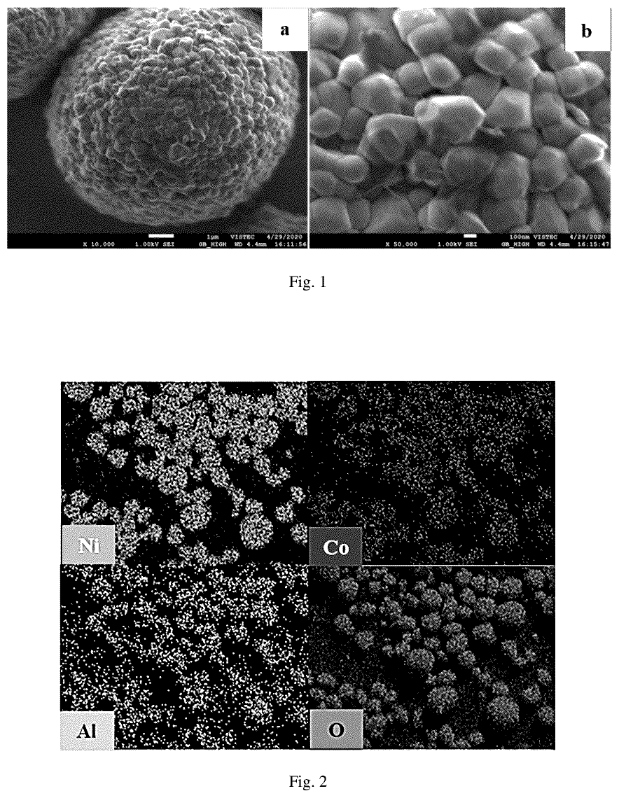

FIG. 1 is images obtained from a scanning electron microscope (SEM) showing the characteristic of the surface of the exemplary cathode active material of the battery. FIG. (1a) shows the characteristic of lithium nickel cobalt aluminum oxide material having a particle size of 10-12 μm which consists of small particles in an orderly arrangement (as clearly shown in FIG. (1b)).

FIG. 2 shows the analysis of elements of the cathode active material using the EDS. It was found that the elements which are the main components of the cathode active material are nickel, cobalt, aluminium, and oxygen which are dispersed extensively. The quantitative measurement of components and ratios of those elements is shown in Table 1.

TABLE 1

| Element | Content of Element (%) | Ratio (%) |
|---|---|---|
| Nickel | 33.6 | 86 |
| Cobalt | 3.7 | 10 |
| Aluminium | 1.6 | 4 |
| Oxygen | 61.1 | — |

According to Table 1, the ratio of nickel to cobalt to aluminium of the cathode active material is 0.86:0.10:0.04, which shows a high ratio of nickel.

### Study on the Crystal Structure of the Cathode Active Material

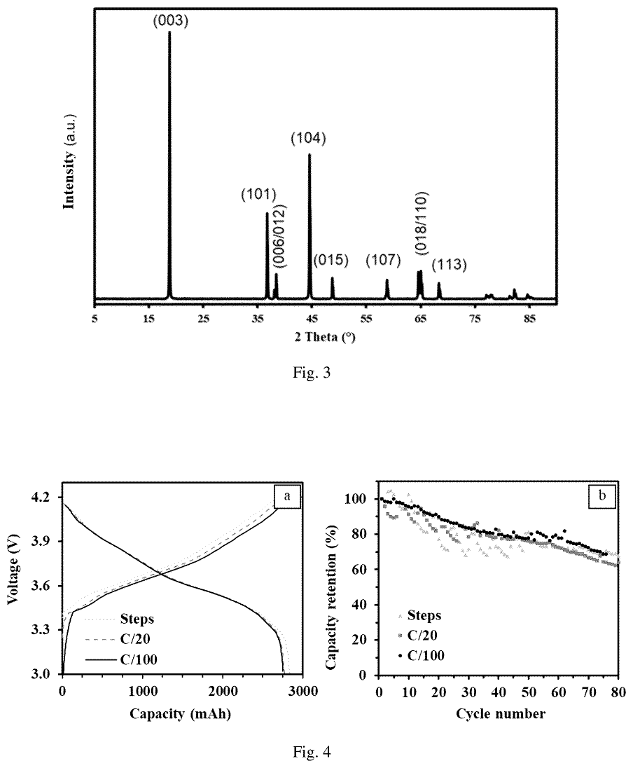

FIG. 3 is a graph obtained from an X-ray diffraction (XRD) analyzer of lithium nickel cobalt aluminum oxide of the battery cathode. It can be seen from the graph that lithium nickel cobalt aluminum oxide material has the R3m̅ structure having planes 003, 101, 006/102, 104, 105, 107, 108/110, and 113 which indicates an orderly arrangement of the crystal structure of lithium nickel cobalt aluminum oxide material and confirms that lithium nickel cobalt aluminum oxide material used in the present invention is an Ni-rich NCA, which provides a high capacity battery, compared to the battery with different cathode active materials.

### Study on the Battery Formation Process

A study was conducted to find an optimal condition for the battery formation process. The study result in FIG. (4a) shows the battery capacity after being subjected to the single-step current charging formation process with a C-rate of 0.05 and 0.01, while FIG. (4b) shows the battery capacity after the multi-step current charging (MSCC) from an open circuit potential to a potential of 4.0 V after which a negative current was supplied to make the discharging of 4.0 V become 3.0 V. This formation step is a step of forming a film layer between the electrodes and a stable solid electrolyte interphase (SEI) which greatly affects the battery efficiency. The result of the charge-discharge test shows that the single-step current charging formation at a C-rate of 0.01 gives a stable capacity and shows the least capacity loss compared with other conditions. This capacity effectively indicates the stability of the SEI layer and the battery performance.

Study on the Cathode Substrate Coating Thickness Vs. The Battery's Charge-Discharge Efficiency

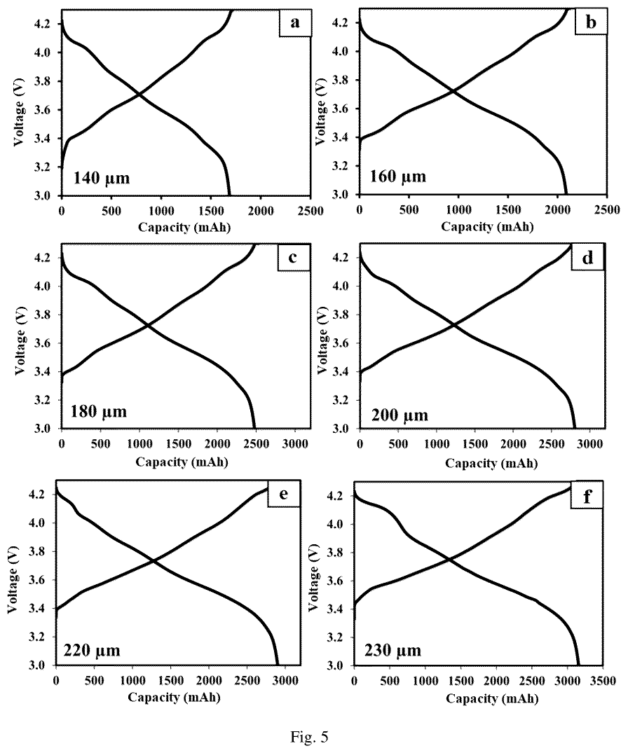

A test was conducted to find a suitable thickness for coating the substrate with the mixture of active material, conductive material, and binder in the preparation of the battery cathode. The test was conducted by testing the charge-discharge capability of the battery of which the cathode substrate is coated at different thicknesses from 140-230 μm. The test result is shown in FIG. 5, which demonstrates the capacity at different thicknesses as shown in Table 2.

TABLE 2

| Substrate coating thickness (μm) | Capacity (mAh) |
|---|---|
| 140 | 1,687 |
| 160 | 2,088 |
| 180 | 2,490 |
| 200 | 2,800 |
| 220 | 2,900 |
| 230 | 3,150 |

It can be seen from Table 2 that upon coating the cathode substrate with the thicknesses of 140 and 160 μm, the battery provides a low capacity which is not sufficient for the battery requirement in the market, which is usually approximately 2,500 mAh or more. However, at the substrate coating thickness of over 180 μm, the battery provides a higher capacity from 2,490-3,150 mAh in accordance with the increasing thickness. Thus, it can be concluded that by increasing the substrate coating thickness, the battery capacity will increase as the amount of active material is increased. However, if the substrate coating becomes too thick, e.g., thicker than 240 μm, the coating will not be smooth, and the cathode material may peel off. Therefore, the thickness range of the cathode substrate coating suitable for the present invention is from 180-230 μm.

Study on the Amount of Fluoroethylene Carbonate Vs. The Battery Charge-Discharge Efficiency

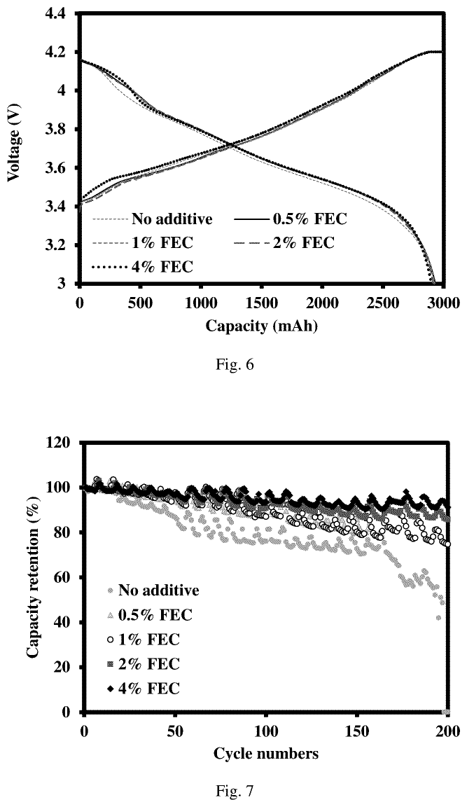

FIG. 6 shows the charge-discharge profile of the batteries having the electrolyte comprising fluoroethylene carbonate (FEC) in an amount of 0.5%, 1%, 2%, and 4% by volume in comparison with the comparative battery which does not contain fluoroethylene carbonate. FIG. 7 shows the capacity retention at different cycle numbers of the batteries having the electrolyte comprising fluoroethylene carbonate in an amount of 0.5%, 1%, 2%, and 4% by volume in comparison with the comparative battery which does not contain fluoroethylene carbonate.

The test result in FIG. 6 suggests that the addition of fluoroethylene carbonate in a range of 0.5-4% by volume does not affect the battery charge-discharge efficiency. All exemplary batteries provide a capacity of up to 2,900 mAh. Accordingly, it can be concluded that the addition of fluoroethylene carbonate does not compromise the battery charging capability.

Additionally, according to the test result in FIG. 7 which shows the battery stability, it can be seen that upon addition of fluoroethylene carbonate, the battery stability was increased. The more fluoroethylene carbonate was added, the more stable the battery was. As seen from the exemplary battery with 4% by volume of fluoroethylene carbonate added, the capacity retention was increased up to 92% at the 200^{th} cycle number, 1.85 times greater than the comparative battery which does not contain fluoroethylene carbonate (the comparative battery provided the capacity retention of 49% at the 200^{th} cycle number).

### Study on the Charge-Discharge Profile of the Battery

FIG. 8 and Table 3 show the charge-discharge profile of the exemplary batteries according to the present invention which suggests that all five exemplary batteries have similar capacity of about 2,800 mAh with the energy density of 240 Wh/kg. This shows that the battery according to the present invention provides a high capacity and can be reproduced. The study on the charge-discharge at different currents reveals that at a C-rate of 1C, the capacity was only reduced by 12%, which is considered a very small decrease compared to the batteries widely available in the market.

TABLE 3

| Cell sequence | Capacity (mAh) | Voltage (V) | Efficiency (%) |
|---|---|---|---|
| 1 | 2,848.6 | 3.68 | 99.5 |
| 2 | 2,853.3 | 3.67 | 99.1 |
| 3 | 2,835.0 | 3.67 | 99.1 |
| 4 | 2,841.4 | 3.67 | 99.2 |
| 5 | 2,851.3 | 3.67 | 99.1 |

### Study on the Battery Charge-Discharge Stability and Efficiency in Wide and Narrow Ranges of Voltage

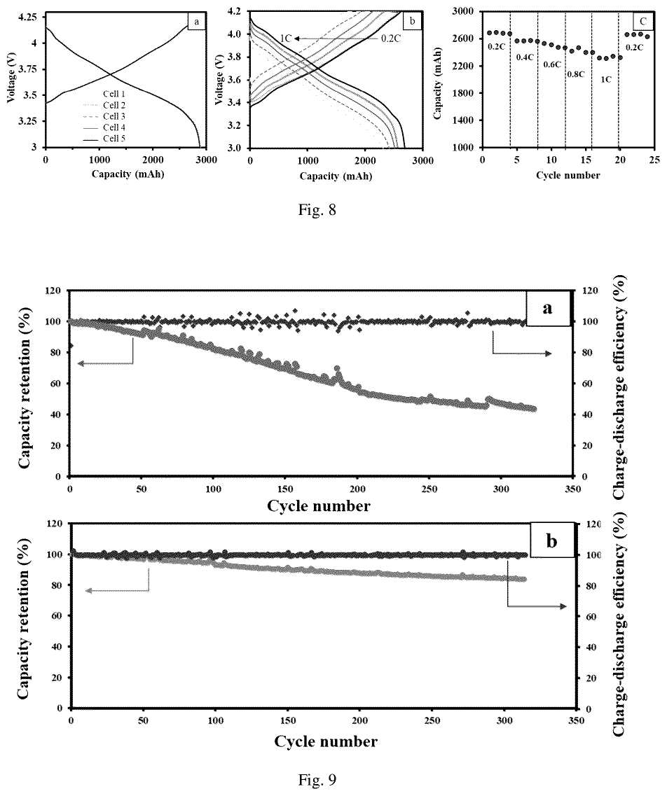

FIG. 9 shows the capacity retention of the battery according to the present invention at different cycle numbers in an application in a voltage range of 3-4.2 V (FIG. (9a)) and 3-4.05 V (FIG. (9b)) at a 1C current.

FIG. 9 shows that after 300 cycles of battery application at the voltage range of 3-4.2 V, the capacity dropped to 46% due to the expansion and contraction of the lithium nickel cobalt aluminum oxide material particles at high voltage which results in a microcracking. However, the remaining capacity of such battery is still higher than that of the NCA battery widely available in the market. Nevertheless, upon decreasing the voltage range to 3-4.03 V, it was found that the capacity was decreased to 85% after 300 charge-discharge cycles, suggesting that a suitable voltage range in an application can extend the battery life cycle.

Study on the Characteristic of the Cathode Active Material after 100 Charge-Discharge Cycles

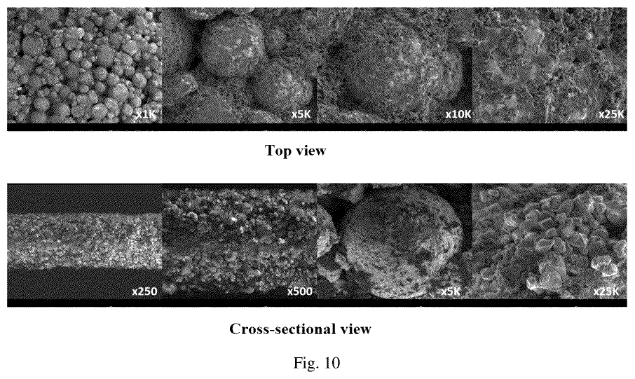

FIG. 10 is images obtained from a scanning electron microscope (SEM) at different magnifications showing the top view and the cross-sectional view of the cathode active material of the battery according to the present invention after 100 charge-discharge cycles. According to images with higher magnification, it was found that the lithium nickel cobalt aluminum oxide particles remained the same with a slight expansion. The cross-sectional images demonstrate that those particles only experienced a small-scale microcracking, effectively indicating the stability of the lithium nickel cobalt aluminum oxide particles when used as a cathode active material in a secondary battery.

### A Study on the Battery Safety

A comparison of the battery without fluoroethylene carbonate and the battery with fluoroethylene carbonate at a concentration of 4% shows that the battery without fluoroethylene carbonate sparked and exploded in an impact test with a dropping height of 61 cm and a steel ball weight of 9 kg according to the UN 38.3 standard. However, upon addition of fluoroethylene carbonate to the electrolyte solution, the battery safety was increased, and the battery did not explode in the impact test with the same height and weight.

Table 4 shows the safety test result of the battery according to the present invention. The impact test was conducted to detect an internal short circuit in three cells.

TABLE 4

| Cell sequence | Voltage (V) | Test result |
|---|---|---|
| 1 | 4.201 | Pass |
| 2 | 4.158 | Pass |
| 3 | 4.16 | Pass |

### BEST MODE OF THE INVENTION

Best mode of the invention is as described in the detailed description of the invention.

1. A lithium-ion battery comprising:
a cathode comprising an active material comprising lithium nickel cobalt aluminum oxide (NCA) compound,
an anode comprising an active material comprising graphite, and
an electrolyte comprising lithium salt, carbonate solvent, and an additive,
wherein lithium nickel cobalt aluminum oxide compound has a formula Li(NiₐCo_{b}Al_{c})O₂, whereby a≥0.85, 0<b<1, 0<c<1 and the sum of a, b, and c is 1, and the additive is fluoroethylene carbonate in an amount ranging from 0.2-4 vol % based on the total amount of electrolyte.

2. The lithium-ion battery according to claim 1, wherein lithium salt is selected from lithium hexafluorophosphate (LiPF₆), lithium oxalyldifluoroborate (LiODFB), lithium tetrafluoroborate (LiBF₄), lithium bis(oxalato)borate (LiBOB), lithium bis(trifluoromethanesulfonyl)imide (LiTFSI), lithium perchlorate (LiClO₄), and a mixture thereof.

3. The lithium-ion battery according to claim 1, wherein the carbonate solvent is a mixture of ethyl carbonate, dimethyl carbonate, and ethyl methyl carbonate.

4. The lithium-ion battery according to claim 3, wherein a volume ratio of ethyl carbonate to dimethyl carbonate to ethyl methyl carbonate is 1:1:1.

5. The lithium-ion battery according to claim 1, wherein the cathode further comprises a conductive material, which is carbon material, and a binder, which is polyvinylidene fluoride (PVDF).

6. The lithium-ion battery according to claim 5, wherein a weight ratio of active material to conductive material to binder is in a range of 90-95.2 to 2.4-5 to 2.4-5.

7. The lithium-ion battery according to claim 1, wherein the anode further comprises a conductive material, which is carbon material, and a binder, which is carboxymethyl cellulose (CMC), and styrene-butadiene rubber (SBR).

8. The lithium-ion battery according to claim 7, wherein a weight ratio of active material to conductive material to binder to carboxymethyl cellulose to styrene-butadiene rubber is 96.6:0.9:1.3:1.2.

9. The lithium-ion battery according to claim 1 which is a cylindrical battery.

10. The lithium-ion battery according to claim 1 which is used at a voltage ranging from 3-4.2 V.

11. A method for preparing a lithium-ion battery comprising the steps of:
(a) preparing a cathode by coating a substrate with a mixture of active material comprising lithium nickel cobalt aluminum oxide (NCA) compound, conductive material, and binder in a solvent and drying the coated substrate,
(b) preparing an anode by coating a substrate with a mixture of active material comprising graphite, conductive material, and binder in a solvent and drying the coated substrate,
(c) assembling the cathode obtained from step (a) and the anode obtained from step (b) in a battery case, and
(d) filling an electrolyte comprising lithium salt, carbonate solvent, and an additive into the battery assembled in step (c),
wherein the filling of electrolyte in step (d) is carried out with a weight ratio of electrolyte to battery ranging from 1-1.3 to 8-9, and
lithium nickel cobalt aluminum oxide compound has a formula Li(NiₐCo_{b}Al_{c})O₂, whereby a≥0.85, 0<b<1, 0<c<1 and the sum of a, b, and c is 1, and the additive is fluoroethylene carbonate in an amount ranging from 0.2-4 vol % based on the total amount of electrolyte.

12. The method according to claim 11, wherein the mixture of active material, conductive material, and binder in the solvent according to step (a) is obtained by a stirring under vacuum.

13. The method according to claim 11, wherein the mixture of active material, conductive material, and binder in the solvent according to step (a) has a viscosity ranging from 6,500-7,000 cP.

14. The method according to claim 11, wherein the coating of the substrate with the mixture of active material, conductive material, and binder in the solvent according to step (a) is performed at a coating thickness ranging from 180-230 μm.

15. The method according to claim 11, wherein the drying of the coated substrate according to step (a) is carried out by heating at a temperature ranging from 120-140° C.

16. The method according to claim 11, wherein the substrate according to step (a) is aluminium.

17. The method according to claim 11, wherein the mixture of active material, conductive material, and binder in the solvent according to step (b) is obtained by a stirring under vacuum.

18. The method according to claim 11, wherein the mixture of active material, conductive material, and binder in the solvent according to step (b) has a viscosity ranging from 5,200-5,500 cP.

19. The method according to claim 11 wherein the coating of the substrate with the mixture of active material, conductive material, and binder in the solvent according to step (b) is performed at a coating thickness ranging from 180-230 μm.

20. The method according to claim 11, wherein the drying of the coated substrate according to step (b) is carried out by heating at a temperature ranging from 100-120° C.

21. The method according to claim 11, wherein the substrate according to step (b) is copper.

22. The method according to claim 11, wherein the filling of electrolyte to the battery according to step (d) is performed in an atmosphere where humidity and oxygen is lower than 0.1 ppm.

23. The method according to claim 11 further comprises step (e) of formation of the battery obtained from step (d).

24. The method according to claim 23, wherein the formation according to step (e) is carried out by a single-step constant current charging at a C-rate in a range of 0.01-0.05C or a 2-4-step constant current charging.

25. The method according to claim 11, wherein lithium salt is selected from lithium hexafluorophosphate (LiPF₆), lithium oxalyldifluoroborate (LiODFB), lithium tetrafluoroborate (LiBF₄), lithium bis(oxalato)borate (LiBOB), lithium bis(trifluoromethanesulfonyl)imide (LiTFSI), lithium perchlorate (LiClO₄), and a mixture thereof.

26. The method according to claim 11, wherein the carbonate solvent is a mixture of ethyl carbonate, dimethyl carbonate, and ethyl methyl carbonate.

27. The method according to claim 13, wherein a volume ratio of ethyl carbonate to dimethyl carbonate to ethyl methyl carbonate is 1:1:1.

28. The method according to claim 11, wherein the mixture of cathode active material comprises the conductive material which is carbon material, and the binder which is polyvinylidene fluoride (PVDF).

29. The method according to claim 15, wherein a weight ratio of the cathode active material to conductive material to binder is in a range of 90-95.2 to 2.4-5 to 2.4-5.

30. The method according to claim 11, wherein the mixture of anode active material comprises the conductive material which is carbon material, and the binder which is carboxymethyl cellulose (CMC) and styrene-butadiene rubber (SBR).

31. The method according to claim 17, wherein a weight ratio of the anode active material to conductive material to binder to carboxymethyl cellulose to styrene-butadiene rubber is 96.6:0.9:1.3:1.2
